(19) United States
(12) Patent Application Publication
(10) Pub. No.: US 2004/0076934 A1
(43) Pub. Date: Apr. 22, 2004

(54) Multimedia foreign language sentence making training system and method thereof without hints in the parent language

(76) Inventors: Say-Ling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 10/273,952

(22) Filed: Oct. 21, 2002

(51) Int. Cl. G09B 19/06; G09B 19/08

(52) U.S. Cl. 434/157

(57) ABSTRACT

A multimedia foreign language sentence making training system and method without hints in the parent language employs multimedia contents for training sentence making and enabling users to understand the contents quickly, thereby enhancing users' sentence making ability and self expression in a foreign language.

### FIELD OF THE INVENTION

The invention relates to a computer-aided language training system and method thereof, and particularly an interactive training system and method thereof adopted for use in foreign language sentence making training that employs multimedia hints without relying on the parent language.

### BACKGROUND OF THE INVENTION

The purpose of learning any foreign language is to use the language at will and be able to fluently hear, speak, read and write. In order to use the language freely in practical situations, learners have to thoroughly understand the essence of the language. In other words, learners should have a deep understanding of the sentence. As the sentence is the basic unit of a language, learners have to fully understand the structure and composition, arrangement sequence and format variations of the sentence to use it confidently. In fact, the ability to make a sentence is the foundation of enhancing the skill of hearing, speaking, reading and writing a language. For the novice of a foreign language, to learn how to make and use the sentence is an essential step to gain the fundamental ability to hear, speak, read and write the language.

Although there are many computer-aided foreign language training systems on the market, most of them adopt the same method, i.e. using the parent language (mother tongue) as the basis of the training. They mostly provide some simple contexts or translations as hints, and couple with a simple learner answering mechanism for training use. Such a training method generates some problems, notably: providing hints in a printed text format does not effectively raise or sustain learners' interest and cannot achieve the desired learning results; the learners do not fully understand the meaning of the simple hints in the text in a short time period or the meaning of the topic is misunderstood when in the parent language, with the result that learners cannot answer questions correctly or quickly; translation of the hints in the parent language bears the constraints of the parent language, and becomes a burden for organizing and expressing the answer; as a result, to express the real content in the foreign language becomes more difficult. All the problems set forth above impact the effectiveness of training for foreign language sentence making.

Therefore, the present invention aims at developing a more effective method based on the disadvantages of the conventional computer-aided language training methods. Scholars or computer-aided instruction (CAI) experts have still not provided any effective theory or training method, so the invention aims at offering a simpler computer-aided language training system that employs more sophisticated computer technology to overcome the drawbacks of traditional methods and enable learners to effectively enhance their sentence making ability in foreign languages.

### SUMMARY OF THE INVENTION

The primary object of the invention is to provide a multimedia foreign language sentence making training system and method thereof to resolve the problems mentioned above. The invention employs multimedia materials (such as images, animations, pictures and voices) without the parent language as hints to enable learners to understand quickly the contents and to express themselves correctly. Through a complete interactive foreign language sentence making training environment the invention enhances learners' ability to make sentences and express themselves in a foreign language.

In order to achieve the object set forth above, the multimedia foreign language sentence making training system of the present invention includes a sentence generation module, a multimedia sentence database, a sentence input judgement module and a central signal monitoring module.

In addition, the multimedia foreign language sentence making training method of the present invention includes the steps of: determining the sentence type in a random fashion, outputting the hint of the sentence type and receiving the user's answer, comparing and judging the contents of the user's answer, and adjusting the sentence making training based on the judgment thereby completing the training cycle of the sentence.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system architecture of the multimedia foreign language sentence making training system and method thereof of the present invention.

FIG. 2 is a schematic view of the sentence data structure of the present invention.

FIG. 3 is the main flowchart of the present invention.

FIG. 4 is the hint answer flowchart of the invention.

FIG. 5 is a schematic view of an embodiment of the present invention.

### DESCRIPTION OF THE PREFERRED EMBODIMENT

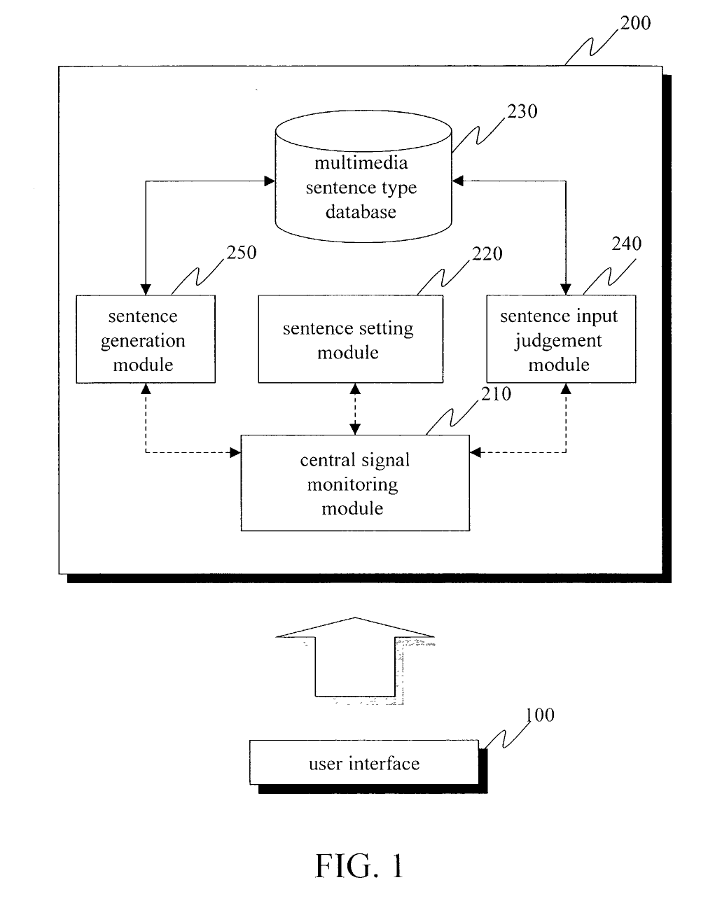

The present invention aims at providing a multimedia foreign language sentence making training system and method thereof without hints in the parent language to overcome the disadvantages of existing foreign language sentence making training methods. The invention is a simple computer-aided language learning system and method to resolve the conventional problems. Users may enter the system and participate in the training through a user interface (UI) 100. FIG. 1 illustrates the main system architecture of the present invention, described in details as follows:

1. The central signal monitoring module 210 monitors operations executed by users through the user interface (UI) 100 (such as initiation, playing, reading, continuing, stopping, inputting, etc.), generates corresponding operation control signals, and transmits the signals and executes operations by linking to the modules in the following.

2. The sentence setting module 220 provides settings when sentences making training is proceeding. It includes settings for hint playing (such as playing items, playing speed, etc.), settings for rules of rearrangement, and settings for input of answers, etc. (such as answering method, answering time, task adjustment, etc.).

3. The multimedia sentence type database 230 stores at least one sentence type, including the code of the sentence type, context of the sentence type, sentence example, sentence type hint and sentence type pronunciation. The database also stores related multimedia data files.

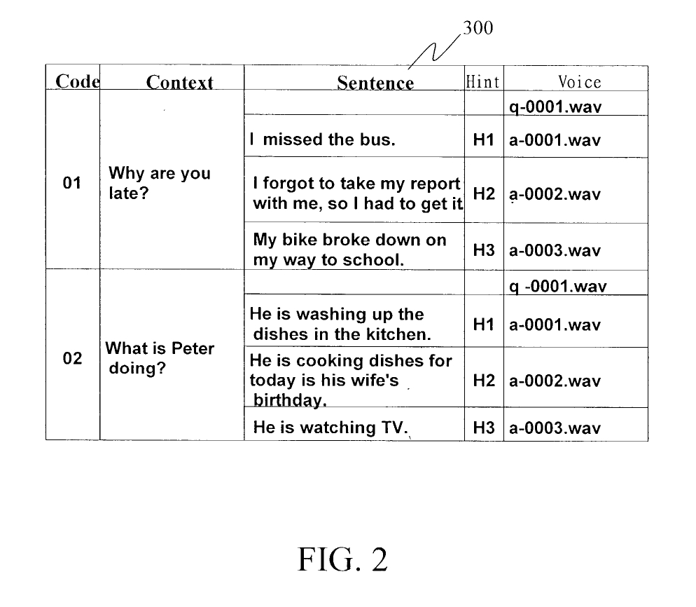

Refer to FIG. 2 for the sentence data structure of the multimedia sentence type database 230. As shown in the drawing, every sentence has a unique code that is the only basis for retrieving the sentence. In addition, every sentence has a set of voice files regarding the context of the sentence type. The sentence type further includes a plurality of different combinations of sentences, and corresponding voices and hints for user training when making sentences in the foreign language.

The sentence data structure may simultaneously store various forms of multimedia data files (including images, animations, pictures and voices), and provide a plurality of practice sentences. By offering rich multimedia presentations, user's learning effect and interest can be enhanced, and users can also learn many different types of expressions in the foreign language from the contexts.

4. The sentence input judgment module 240 receives users' input, and compares the contents entered by the users. Users may enter input through peripheral input devices (such as a keyboard, mouse, digital touch pad and voice system). This module 240 receives user's input contents and stores them, and compares with the original sentence one by one according to the First In First Out (FIFO) principle.

5. The sentence generation module 250 generates sentences in a random fashion. A random number generator is employed to produce random numbers to retrieve the sentences in the multimedia sentence database 230.

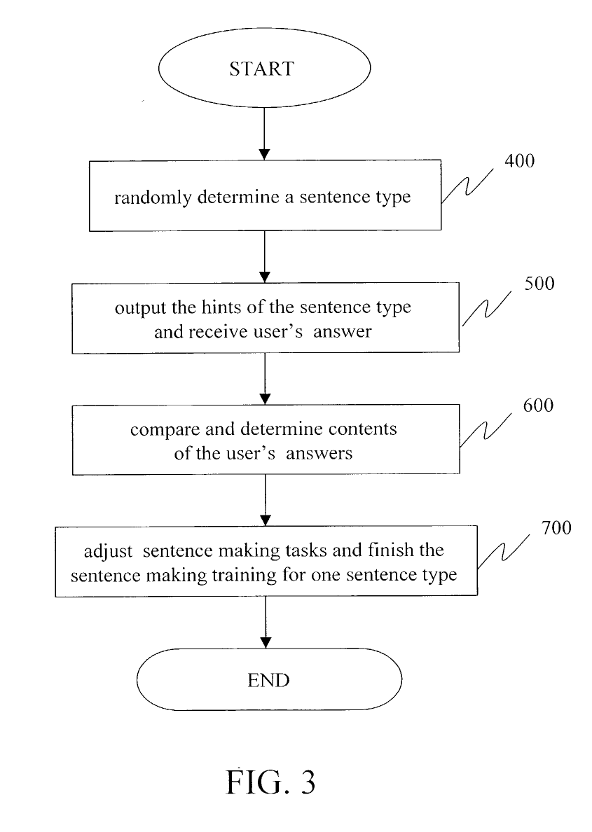

Refer to FIG. 3 for the main process flow of the method of the invention, with the details described as follows.

First, a user activates the foreign language sentence making training system 200 of the invention, and through a random sentence generation method determines a specific sentence type (step 400); playing the hints of the determined sentence type retrieved from the multimedia sentence database 230, and receiving user's input answer after playing the hints (step 500); the system 200 starts comparison after the user has finished the answer (step 600); completing one cycle of sentence training operations (step 700) and end the process flow.

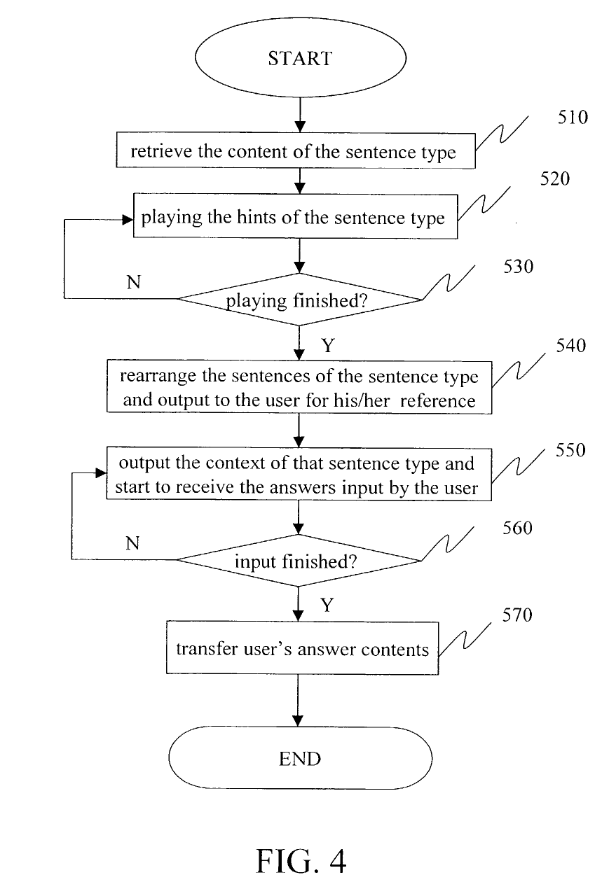

Refer to FIG. 4 for the answering process, with the details described as follows.

First, when the system determines a specific sentence type, it retrieves the content of that sentence type from the multimedia sentence type database 230 (step 510), including the contexts of the sentence type, the sentences of the sentence type, hints for the sentence type and voices of the sentence type. The system then plays the hints of the sentence type according to the settings in the sentence setting module 220 (step 520), and determines if the playing is finished (step 530). It continues playing if it is not finished; otherwise it rearranges the sentences of that sentence type and outputs to the user for the user's reference for the next answer (step 540). Next the system outputs the contexts of that sentence type and starts to receive the answer input from the user (step 550). The user may enter input through input peripheral devices (such as a keyboard, mouse, digital touch pad and voice system), and the system 200 automatically determines whether the input from the user is finished (step 560). If the user does not finished inputting, the system continues to receive input from the user, otherwise it stores the user's answers. Finally the answering process is completed and the system returns to the main process.

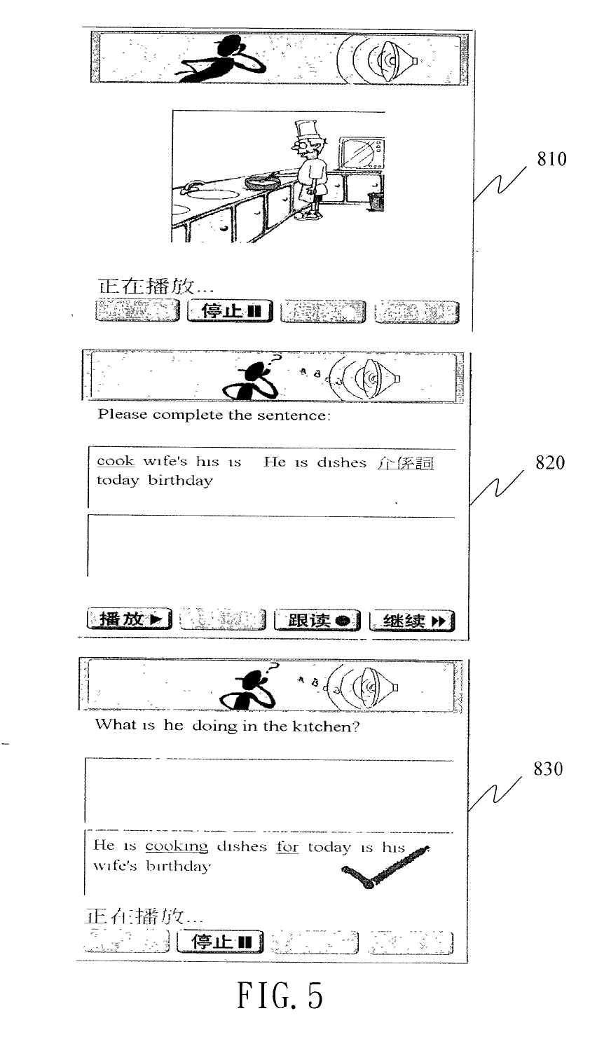

Refer to FIG. 5 for an embodiment which illustrates the present invention.

First, the initial picture in the foreign language sentence making training process is a picture showing the hint of a sentence type (810). At this stage, the system 200 may present the hint through various multimedia contents (such as animation and voice shown in the drawing). When the hint is finished, the system 200 displays the picture of rearranging the sentence type 820. As shown in the picture, the sentence has been rearranged randomly. This mainly aims to enable the user to understand in advance the composing elements of the sentence so that the user can answer quickly and correctly later. Finally the system 200 displays a picture for input, comparison and determination 830. When the context of the sentence appears (such as “What is he doing in the kitchen?” shown in the picture), the user may enter answers. After the user has finished the answer (i.e. “He is cooking dishes because today is his wife's birthday” shown in the picture), the system 200 immediately processes comparison and determination operations, and decides whether to approve the task and give the next task, or to correct the answer and repeat the same task.

In summary, the multimedia foreign language sentence making training system and method without hints in the parent language of the invention employs sophisticated computer and multimedia technologies to provide a complete interactive environment to aid users in enhancing their sentence making ability in a foreign language.

The invention does not rely on the parent language to offer hints. Instead, a multimedia broadcasting method is adopted to provide the hints to train sentence making without employing the parent language. Users may correctly and quickly express their own thoughts without the influence of the mother tongue. Thus users may be freed from the burden of the translated hints in the parent language, which often result in dull and unnatural expressions, or are misleading or confusing due to improperly translated content.

In addition, through broadcasting the multimedia contents of the hints, users can have a clearer understanding of the contents and greatly reduce the thinking time when expressing in the foreign language. Trained by the system and method of the invention for a period of time, users do not have to rely on the hints of the parent language, and can easily make sentences or communicate in the foreign language. The training of the invention is also lively and vivid, and can increase users' sustained interest and enthusiasm for learning.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A multimedia foreign language sentence making training system without hints in a parent language, for enhancing users' ability in making sentences in a foreign language, comprising:
a multimedia sentence type database for storing at least one sentence type;
a sentence generation module for generating sentences in a random fashion according to a code of the sentence type;
a sentence input judgement module for comparing answers input by the users; and
a central signal monitoring module for monitoring operations executed by the users and generating corresponding control signals, and transmitting the signals and processing operations through linking to the modules.

2. The system of claim 1, further comprises a sentence setting module for providing settings of a sentence making training approach.

3. The system of claim 1, wherein the sentence making training approach includes settings of a hint playing, a rearrangement rule and an answer entering.

4. The system of claim 3, wherein the entering answers is done in a form of words or voices through an peripheral input device.

5. The system of claim 1, wherein the multimedia sentence type database stores data files including images, animations, pictures and voices.

6. The system of claim 1, wherein the sentence type includes a code of the sentence type, a context of the sentence type, a sentence of the sentence type, a hint of the sentence type and a voice of the sentence type.

7. The system of claim 6, wherein the hint of the sentence includes images, animations, pictures and voices without the parent language.

8. The system of claim 1, wherein the comparing and determining answers includes storing contents of the users' answers in a queue and comparing with the sentences of the sentence type according to a first-in-first-out principle.

9. A multimedia foreign language sentence making training method without hints in a parent language, for enhancing users' ability in making sentences and self expression in a foreign language, comprising the steps of:
determining a sentence type randomly;
outputting the hints of the sentence type and receiving users' input answers;
comparing the users' input answers; and
adjusting missions of the sentence making thereby finishing the sentence making training of the sentence type.

10. The method of claim 9 further including setting a sentence making training approach.

11. The method of claim 10, wherein the sentence making training approach includes settings of a hint playing, a rearrangement rule and a answers entering.

12. The method of claim 9, wherein the sentence type includes a code of the sentence type, a context of the sentence type, a sentence of the sentence type, a hint of the sentence type and a voice of the sentence type.

13. The method of claim 12, wherein the hint of the sentence type includes images, animations, pictures and voices without the parent language.

14. The method of claim 9, wherein the entering input answers is done in a form of words or voice through a peripheral input device.

15. The method of claim 9, wherein the outputting the hints of the sentence type and receiving users' input answers includes the steps of:
retrieving the sentence type;
playing the hints of the sentence type;
rearranging the sentences of the sentence type and outputting for users' references;
outputting contexts of the sentence type and receiving users' inputs; and
transferring contents of the users' input answers.

16. The method of claim 9, wherein the comparing and determining input answers includes storing contents of the users' answers in a queue and comparing with the sentences of the sentence type according to a first-in-first-out principle.
